(19) United States
(12) Patent Application Publication
(10) Pub. No.: US 2001/0034721 A1
(43) Pub. Date: Oct. 25, 2001

(54) System and method for providing services to a remote user through a network

(76) Inventors: Jean-Pierre Boudreau, St-Eustache (CA); Alain Fortin, Montreal (CA); Philippe Duval, Montreal (CA); Michel Tyers, Kirkland (CA)

Correspondence Address: MERCHANT & GOULD PC, P.O. BOX 2903, MINNEAPOLIS, MN, 55402-0903, US

(21) Appl. No.: 09/783,622

(22) Filed: Feb. 14, 2001

Related U.S. Application Data
(60) Provisional application No. 60/182,184, filed on Feb. 14, 2000.

(51) Int. Cl. G06F 17/60; G06F 7/00; H04K 1/00; H04L 9/00; G06F 17/30

(52) U.S. Cl. 705/72; 705/64; 705/70; 705/71; 707/9; 707/10

(57) ABSTRACT

A system and method for providing services to a remote user through a network is provided. The user is identified through a user personal CD card readable in a CD reading device of a terminal, and a user personal identification number (PIN) entered on this terminal. The PIN and card-identifying elements are transmitted from the terminal to a remote server through the network, and matched to a user profile on the server, thereby identifying the user. The identified user may be provided with access to at least one service application on said server, such as access to a restricted system or financial transactions.

### FIELD OF THE INVENTION

The present invention relates to the field of remote operations through a network, and more particularly concerns a system and method for securely identifying a remote user and providing this user services through a network.

### BACKGROUND OF THE INVENTION

With the ever increasing popularity of operations over the internet and networks in general, the security of such operations is an important concern of businesses and users alike. A particular aspect of these security considerations is the proper identification of a remote user. The preferred method of identification is the provision of secret passwords, but such passwords are vulnerable to attacks from hackers who can easily impersonate a particular user once his password has been cracked. It is also known in the art to provide user identification through biometrics characteristics, but such systems require complex equipment and are not readily available to the general population.

Another security concern with internet and network operations is the circulation of sensitive personal information through a network, such as a credit card number or a password. Again, once this information has been accessed by a third party, it can be used to impersonate the user without his consent.

There is therefore a need for a more secure manner of providing services to a user through a network.

### OBJECTS AND SUMMARY OF THE INVENTION

It is therefore an object of the present invention to provide a system and method for providing services to a user through a network that include securely identifying a remote user.

It is a preferred object of the invention to provide such a system and method where it is not necessary for the user to provide personal information through the network.

Accordingly, the present invention concerns a system for providing services to a remote user through a network, including identifying means for identifying the user. These identifying means include a user personal CD card readable in a CD reading device of a terminal, and a user personal identification number (PIN) enterable on the terminal. This two-factor identification system is based on what the user knows (PIN) and something the user has (card). A transmitter is provided for transmitting the PIN and card-identifying elements from the terminal to a remote server through the network. A matching application is provided on the server for matching the PIN and card-identifying elements to a user profile, thereby identifying the user.

The system also includes at least one service application available to the identified user on said server.

The present invention also concerns a method for providing services to a remote user through a network, including the steps of:

A- identifying said user by performing the substeps of:

a) reading a user personal CD card in a CD reading device of a terminal;

b) entering a user personal identification number (PIN) on the terminal;

c) transmitting the PIN and card-identifying elements from the terminal to a remote server through the network; and

d) matching the PIN and card-identifying elements on to a user profile on the server, thereby identifying said user; and

B- providing the identified user with access to at least one service application on said server.

As a particularly advantageous embodiment of the invention, there is provided a method for allowing a user to securely purchase goods from a merchant's web site. The method includes the steps of:

i) identifying said user according to step A described above;

ii) providing a temporary credit number linked to a credit or debit account of said user, said temporary credit number being valid for a single transaction;

iii) transmitting said temporary credit number to the user; and

iv) entering the temporary credit number as payment for said goods on the merchant's web site.

Other features and advantages of the invention will be better understood upon reading of preferred embodiments thereof with reference with the accompanying drawings.

### BRIEF DESCRIPTION OF THE DRAWINGS

FIG. 1 is a schematic representation of a system according to a preferred embodiment of the invention.

FIG. 2 is diagram showing the service application loading process of the system of FIG. 1.

FIG. 3 is a diagram showing the general architecture of the system of FIG.

FIG. 4 is a flow chart illustrating a method according to a preferred embodiment of the invention.

FIG. 5 is a schematic representation of a system and method for allowing a user to purchase goods from a merchant's web site according to another aspect of the invention.

### DESCRIPTION OF PREFERRED EMBODIMENTS OF THE INVENTION

Description of a System According to a Preferred Embodiment

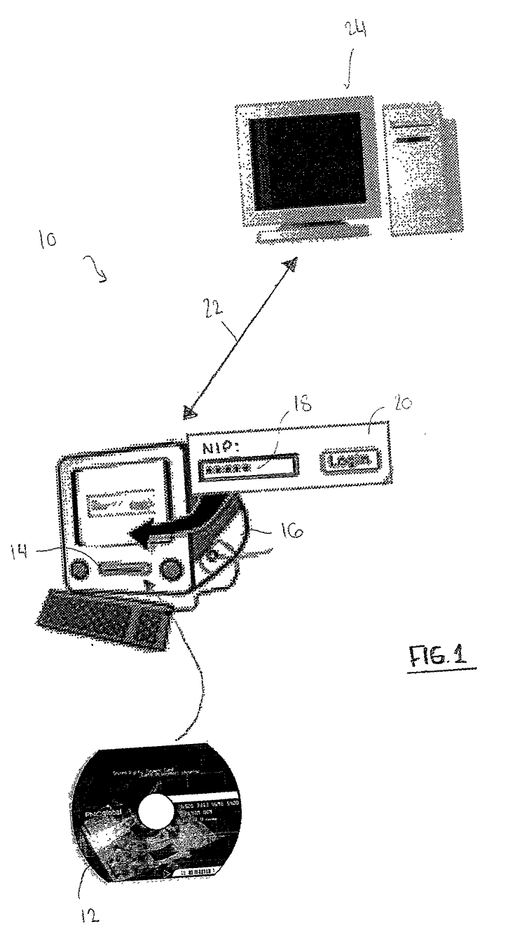

With reference to FIGS. 1, 2 and 3, there is shown a system 10 for providing services to a remote user through a network according to a preferred embodiment of the invention.

The system 10 first includes a user personal CD card 12, which is readable in a CD reading device 14 of a terminal 16. The CD card 12 is preferably of the universally accepted CD Card format and may be run in any CD or DVD players such as found on most personal computers today. The terminal may be a personal computer or a dumb terminal, as long as it is provided with a CD reading device 14 and some type of connection to a network.

The system 10 further includes a user personal identification number, or PIN 18, which is the sole knowledge of the user, and which is to be entered on the terminal 16. As seen in FIG. 1, the system preferably prompts the user for the PIN 18 in window box 20. A transmitter 22 is provided for transmitting the PIN 18 and card-identifying elements from the terminal 16 to a remote server 24 through the network. The transmitter 22 is preferably embodied by any appropriate manner of sending information from a computer, such as a modem and phone, cable, or satellite connection, etc.

In the preferred embodiment of the invention, an encryption code is provided on the CD card for encrypting the PIN 18. RSA technology such as private/public key pairs are preferably used. The encryption code thereby defines the card-identifying elements since each CD card has a unique key pair (or other encryption characteristics). On the side of the server 24 a matching application is provided for matching the PIN 18 and card-identifying elements to a user profile on the server, which preferably includes a database of user profiles. If both the PIN 18 and the card-identifying elements match the data of a given user, the user is positively identified. In this manner both the PIN 18 and the CD card 12 are required for identification.

Once the user has been properly identified, at least one service application is made available to him on the server. Preferably, applet 25 such as a JAVA applet linked to the service application is transmitted to the terminal. Java applets are advantageous for internet operations since they have restricted privileges when running on a local terminal. They cannot read or write to a file, nor can they access the system's properties. Different security models are available to sign a Java applet: Microsoft Internet Explorer (trademark), Netscape Navigator (trademark), Sun JDK 1.1 (trademark) Sun JDK 1.2 (trademark), etc. Another advantage of this embodiment is that no application is needed on the terminal itself, and no information is left thereon once a given session is finished.

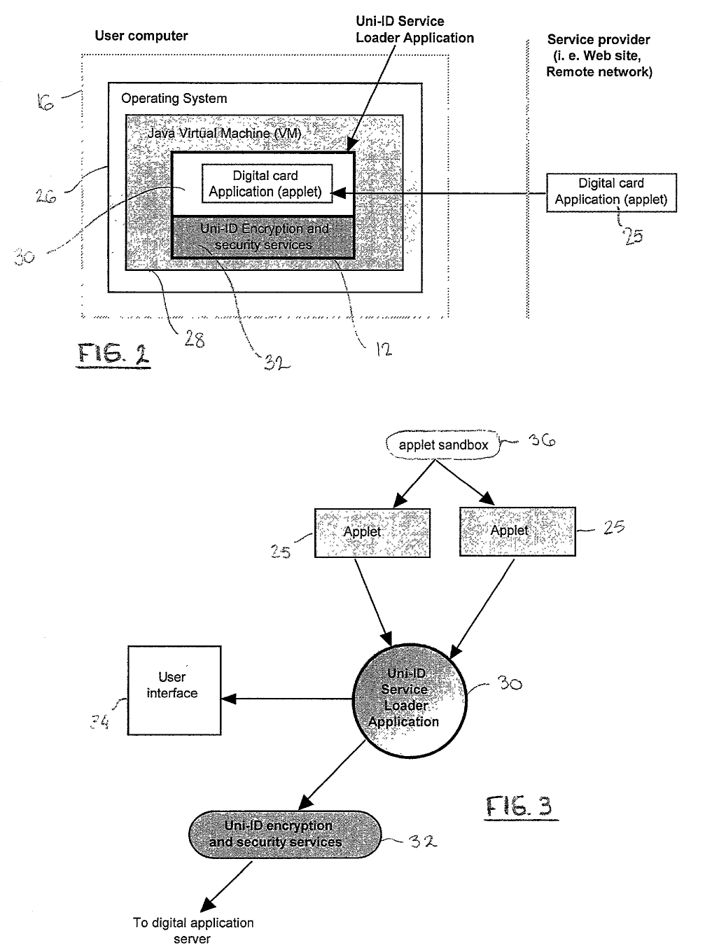

FIG. 2 illustrates an example of a service application loading process. In this example, the terminal 16 is a computer having an operating system 26 configured to accept Java applets, as indicated here by Java Virtual Machine 28. The CD card 14 has two card resident applications, a service loader application 30 for loading the Java applet 25 and an encrypting application 32 for providing the encrypting code described above.

FIG. 3 summarizes the architecture of a system according to the present embodiment of the invention. At the center is the service loader application 30, run on the terminal from the CD card. The service loader application 30 received information in the form of applets 25 each running in its own applet sandbox 36 on the server 24. Optionally, an applet 25 can publish itself for other applets providing its own secret key. Output information is either directed to the user interface 36, or encrypted by the encrypting application 32 before exiting the user terminal.

Numerous service applications may be provided on the server 24. Examples are given below.

The system according to the present invention may be used to give the user access to secure systems such as a private network, a private section of a web site, a database of user related information, etc. In such accessing applications, the user's access password or other code may be saved on the server which gives it to the system to be accessed directly once the user has been identified. The system to be accessed may be on the server itself or securely connected to it, so that the password information is never circulated via the internet or other unreliable network.

The present system may also advantageously be used for financial transaction, such as a debit or credit application. In an advantageous embodiment of such an application, an online merchant may provide a CD card payment icon on his web site. When ready to make a purchase, the user may simply insert his CD card in a CD player, and drag the CD card payment icon to the service loader application. A Java applet that encapsulates the functionality to open a connection to the card is downloaded and executes a debit or credit operation from a user account.

In another advantageous embodiment of the present invention, a system according to the present invention may be used to provide the user with a temporary credit number. In this embodiment, the user may want to purchase goods from a merchant's web site. To provide a payment for the goods, the user inserts his CD card in a CD player and identifies himself as explained above. On the server, once the user is identified, a temporary and random credit number is provided linked to the user's credit account. The temporary credit number is valid for a single transaction. The user then simply enters this temporary number instead of his credit card number on the merchant's web site. To validate the transaction, the merchant will forward the number to the user's financial institution. The server will intercept the temporary number and replace it with the user's proper credit number, thereby debiting his credit account. Advantageously, the server may be provided directly as part of the financial institution's system, so that the user's actual credit information never leaves his financial institution.

It is a very advantageous feature of the present invention that the nature and number of service applications provided to the user through the present invention may be changed with time. Since no application-related information has to be written on the card, a same card may be used for various purposes, and new service applications may be made available to a user by simply adding them to his user profile on the server. It is therefore unnecessary to replace the user's card every time or burden the user with a growing set of cards each time his needs evolve. The invention is said to offer multi-services functionalities.

Description of a Method According to a Preferred Embodiment

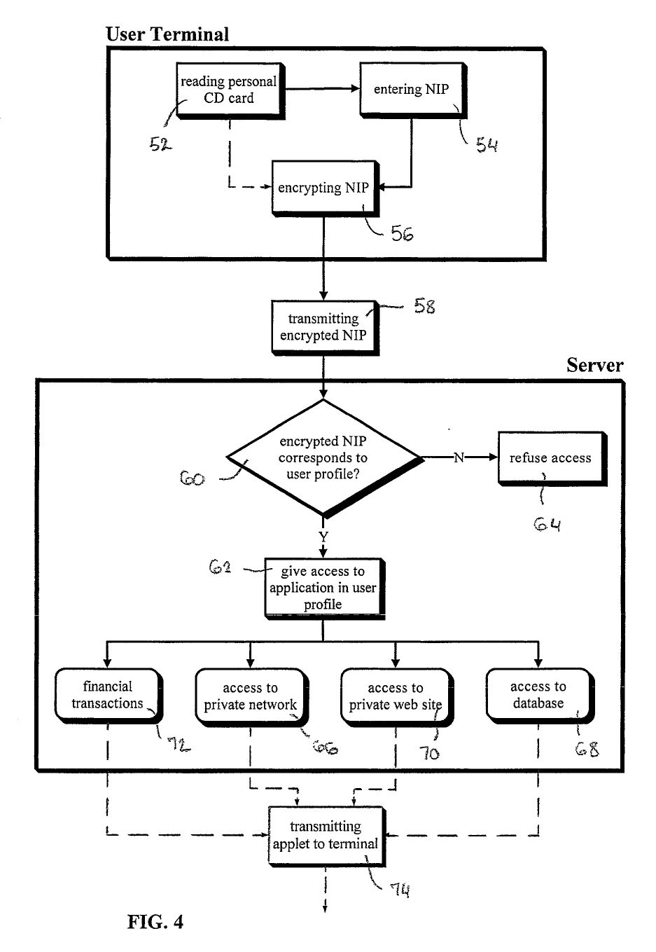

With reference to FIG. 4, the present invention also provides a method 50 for providing services to a remote user through a network. The method 50 includes the following steps of:

A- identifying said user by performing the substeps of:

reading 52 a user personal CD card in a CD reading device of a terminal;

entering 54 a user personal identification number (PIN) on the terminal;

preferably encrypting 56 the PIN with an encryption code. The encryption code is provided on the CD card, and therefore includes card-identifying elements.

transmitting 58 the encrypted PIN, which therefore includes the card-identifying elements, from the terminal to a remote server through the network; and

d) matching 60 the PIN and card-identifying elements on to a user profile on the server, thereby identifying said user. Preferably, the PIN and card-identifying elements are matched to corresponding data in a user profiles database; and

B- providing 62 the identified user with access to at least one service application on the server. Of course, access is denied 64 if no match is established between the transmitted encrypted PIN and a user profile in the database. A plurality of service applications may be available to the user, such as accessing a private network 66, accessing a database of user-related information 68, accessing a private section of a web site 70, or performing financial transactions 72. Preferably, an applet linked to the given service application is transmitted 74 to the terminal.

Description of a Method for Purchasing Goods on a Merchant's Web Site According to a Preferred Embodiment

The present invention allows to provide a user with a variety of services. In a particularly advantageous embodiment of the invention, it provides a method and corresponding system for allowing a user to securely purchase goods from a merchant's web site. The method includes the following steps:

i) identifying said user according to step A described above;

ii) providing a temporary credit number linked to a credit account of said user, the temporary credit number being valid for a single transaction;

iii) transmitting the temporary credit number to the user; and

iv) entering the temporary credit number as payment for said goods on the merchant's web site.

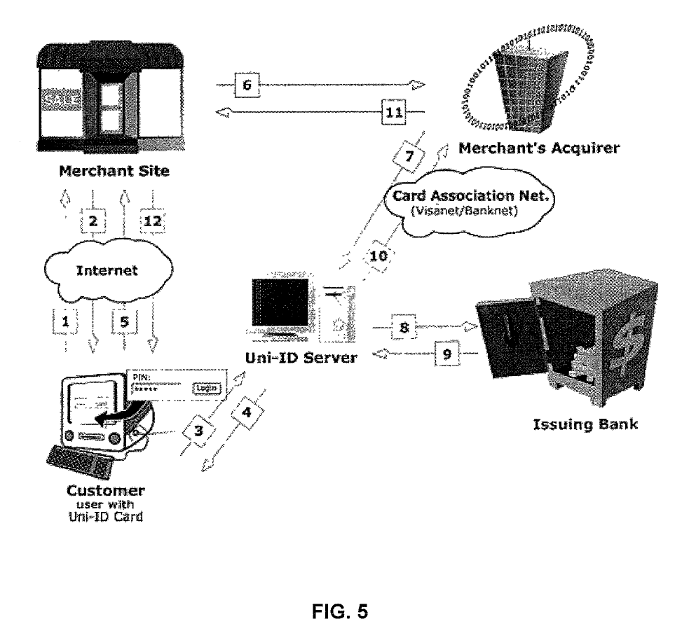

Referring to FIG. 5, there is shown a detailed example of embodiying the above method.

Steps 1 and 2

The consumer having received and activated his CD card, establishes a connection to a merchant's web site. It is not necessary that the merchant's web site be modified to accept payment by the present method. When the consumer is asked to provide his credit card number to complete the transaction, he inserts his CD card in the CD/DVD ROM drive of his PC. It automatically starts up an application that safely connects itself to the server, identifies itself as a CD card and thus receives a dialog box that asks the consumer to type in his personal identification number (PIN).

Steps 3 and 4

The consumer types his PIN which generates an encoded message (RSA Technologies—pair of private/public keys) which is unique each time, and is then sent to the server to validate his identity. When the server identifies the corresponding client's file, it generates a unique credit card number, which is random and temporary and is sent back to the consumer in a secured manner and is associated with him.

Step 5

The consumer only has to:

cut and paste the temporary number received in the space provided for that purpose on the merchant's Web page;

complete the other informations requested; and

send the order form over the Internet.

Step 6

The transaction proceeds regularly and the temporary number (with expiration date) is then sent to the merchant to his “Processor” which proceeds to validate the transaction.

Step 7

The issuing financial institution is identified by the first numbers of the temporary number and the transaction informations are received by the issuing financial institution by way of the “Processor”. The temporary credit number is then sent to the server, preferably located at the financial institution, which associates the temporary number to the file of the client who has requested this number at the beginning of the transaction and pulls out the real credit card number and expiry date. The temporary number is then replaced by the consumer's real credit card number, before being forwarded with the transaction to be validated by the issuing financial institution. The temporary number is then deactivated.

Steps 8 and 9

The issuing financial institution proceeds, in the regular fashion, to the validation of the client's account and returns an acceptance or refusal message for the transaction.

Steps 10, 11 and 12

The regular acceptance or refusal message is then forwarded, in the regular fashion, to the merchant's Web site to inform the consumer.

Advantageously, at no point in the transaction has the real credit card number ever circulated on the Internet, thereby keeping the consumer totally safe.

Of course, numerous modifications could be made to the embodiments described above without departing from the scope of the invention as defined in the appended claims.

What is claimed is:

1. A system for providing services to a remote user through a network, comprising: identifying means for identifying said user, comprising:
a) a user personal CD card readable in a CD reading device of a terminal;
b) a user personal identification number (PIN) enterable on the terminal;
c) a transmitter for transmitting the PIN and card-identifying elements from the terminal to a remote server through the network; and
d) a matching application for matching the PIN and card-identifying elements to a user profile on the server, thereby identifying said user; and at least one service application available to the identified user on said server.

2. A system according to claim 1, wherein said user personal card comprises an encrypting code for encrypting said PIN, said encryption code including said card-identifying elements.

3. A system according to claim 1, wherein the server comprises a user profile databases, each user profile of said database including a PIN and card-identifying elements for matching with the a PIN and card-identifying elements transmitted by the transmitter.

4. A system according to claim 1, further comprising an applet linked to said at least one service application and a transmitter for transmitting said applet from the server to the terminal.

5. A system according to claim 1, wherein said at least one service application includes a plurality of service applications.

6. A system according to claim 1, wherein the at least one service application includes an application for accessing a private network.

7. A system according to claim 1, wherein the at least one service application includes an application for accessing a database of user-related information.

8. A system according to claim 1, wherein the at least one service application includes an application for accessing a private section of a web site.

9. A system according to claim 1, wherein the at least one service application includes an application for performing financial transactions.

10. A system according to claim 9, wherein said application for performing financial transactions comprises:
i) means for providing a temporary credit number linked to a user credit account, said temporary credit number being valid for a single transaction; and
ii) means for transmitting said temporary credit number to the user.

11. A method for providing services to a remote user through a network, comprising the steps of:
A- identifying said user by performing the substeps of:
a) reading a user personal CD card in a CD reading device of a terminal;
b) entering a user personal identification number (PIN) on the terminal;
c) transmitting the PIN and card-identifying elements from the terminal to a remote server through the network; and
d) matching the PIN and card-identifying elements on to a user profile on the server, thereby identifying said user; and
B- providing the identified user with access to at least one service application on said server.

12. A method according to claim 11, wherein step A comprises an additional substep between substeps b) and c) of encrypting said PIN with an encryption code, said encryption code including said card-identifying elements.

13. A method according to claim 11, wherein substep A d) comprises matching the PIN and card-identifying elements to corresponding data in a user profiles database.

14. A method according to claim 11, wherein step B comprises transmitting an applet linked to said at least one service application to the terminal.

15. A method according to claim 11, wherein step B comprises providing the identified user with access to a plurality of service applications.

16. A method according to claim 11, wherein, in step B, the at least one service application includes an application for accessing a private network.

17. A method according to claim 11, wherein, in step B, the at least one service application includes an application for accessing a database of user-related information.

18. A method according to claim 11, wherein, in step B, the at least one service application includes an application for accessing a private section of a web site.

19. A method according to claim 11, wherein, in step B, the at least one service application includes an application for performing financial transactions.

20. A method according to claim 19, wherein said step B comprises substeps of:
i) providing a temporary credit number linked to a user credit account, said temporary credit number being valid for a single transaction; and
ii) transmitting said temporary credit number to the user.

21. A method for allowing a user to securely purchase goods from a merchant's web site, comprising steps of:
i) identifying said user according to step A of claim 11;
ii) providing a temporary credit number linked to a credit account of said user, said temporary credit number being valid for a single transaction;
iii) transmitting said temporary credit number to the user; and
iv) entering the temporary credit number as payment for said goods on the merchant's web site.
